(19) United States
(12) Patent Application Publication
(10) Pub. No.: US 2026/0327444 A1
(43) Pub. Date: Oct. 22, 2026

(54) ERASABLE MARKING COMPOSITION

(71) Applicant: Sanford, L.P., Atlanta, GA (US)

(72) Inventors: Vincent Kwan, Alpharetta, GA (US); Bryan Koepp, Cumming, GA (US)

(21) Appl. No.: 19/476,518

(22) PCT Filed: Apr. 17, 2024
(86) PCT No.: PCT/US2024/024924

§ 371 Date: Oct. 17, 2025

Related U.S. Application Data
(60) Provisional application No. 63/459,737, filed on Apr. 17, 2023.

(51) Int. Cl. C09D 11/17; C09D 11/18

(52) U.S. Cl. CPC C09D 11/17; C09D 11/18

(57) ABSTRACT

Compositions for use in writing instruments that are removable after application, such as by erasure. The compositions include a base resin and a colorant dissolved in a solvent where, after application to a substrate, the composition may be removed after application if desired or necessary.

This is an International (PCT) Patent Application filed for an invention by Vincent Kwan and Bryan Koepp for the disclosure of “Erasable Marking Composition.”

### CROSS-REFERENCE TO RELATED APPLICATION

This application cites the priority of currently pending U.S. 63/459,737 filed 17 Apr. 2023. U.S. 63/459,737 is incorporated herein by reference in its entirety.

### FIELD OF THE INVENTION

The present disclosure relates generally to compositions for use in writing instruments that provide for a non-permanent application. More particularly, the present disclosure provides compositions that include a base resin and a coloring agent suspended in a solvent where, after application to a substrate, the composition may be removed after application if desired or necessary. The present disclosure is also directed to a writing instrument containing the above composition.

### BACKGROUND OF THE INVENTION

Numerous efforts have been directed to erasable writing systems that generally allow users to correct mistakes. For example, U.S. Pat. Nos. 9,695,329, 9,266,379, and 8,173,052 proposed utilization of thermochromic systems that possess a large temperature hysteresis. However, such systems are not completely erasable. In fact, with such systems, the “corrected” or erased writing will reappear upon exposure to extreme low temperature below −10 C. In addition, after erasure by rising temperature, the thermochromic capsules are still visible if written on a colored substrate. As such, the writing is not truly erased; rather, the writing just disappears within a “white” polymer matrix that camouflages over a white background. Moreover, the residual non-colored microcapsules left on the paper surface pose a barrier to “re-writing”.

Accordingly, there remains a need for compositions for use in writing instruments that are readily removable after application. In this aspect, it would be advantageous to have ink compositions that produce high quality markings on a variety of substrates while still being removable in a composite film rather than flakes. The present disclosure provides compositions for allow use in writing instruments and writing instruments containing such compositions that allow for removal of the composition after application.

### SUMMARY OF THE INVENTION

The problems expounded above, as well as others, are addressed by the following inventions, although it is to be understood that not every embodiment of the inventions described herein will address each of the problems described above.

The present disclosure provides compositions that impart colored marks to an intended substrate, but are removable after application. The compositions include at least one polymer, at least one colorant, and at least one solvent. The compositions are capable of developing vibrant color upon application to or contact with a substrate. Another embodiment of the present disclosure provides writing instruments that include and are capable of applying the compositions to a substrate. The compositions may also be substantially erasable.

The present disclosure is also directed to a composition, including a base resin; a pre-assembled colorant having a plurality of particles therein; and a solvent system, wherein the composition satisfies the following relationship:

$$\frac{B {R}_{C} * {S}_{C}}{{C}_{P S} - \frac{{C}_{ST}}{B {R}_{ST}}} \leq 2$$

wherein BR_{C} represents the concentration of base resin in the composition in parts per hundred, wherein S_{C} represents the concentration of solvent in the composition in parts per hundred, wherein C_{PS} represents a percent of particles in plurality of particles having an average particle size of 1 μm to 200 μm, wherein C_{ST} represents the surface tension of the composition, and wherein BR_{ST} represents the surface tension of the base resin. In some embodiments, the pre-assembled colorant includes colorant-coated microspheres, colorant-infused microspheres, colorant-plated pigment flakes, or combinations thereof. In other embodiments, the base resin comprises poly(styrene-butadiene), carboxylate-terminated poly(styrene-butadiene), or mixtures thereof. In still other embodiments, C_{ST} ranges from 20 mN/m to about 40 mN/m. For example, C_{ST} may range from 25 mN/m to about 35 mN/m. In yet other embodiments, the composition may have a storage modulus of about 9×10⁻⁴ MPa to about 1×10⁻⁵ MPa. In other embodiments, the base resin has a storage modulus of about 1×10⁻⁷ MPa to about 1×10⁻³ MPa.

The present disclosure also relates to a composition, including a base resin having a storage modulus of about 1×10⁻⁷ MPa to about 1×10⁻³ MPa; a pre-assembled colorant having a plurality of particles therein; and a solvent system, wherein the composition satisfies the following relationship:

$$\frac{B {R}_{C} * {S}_{C}}{{C}_{P S} - \frac{{C}_{ST}}{B {R}_{ST}}} \leq 2$$

wherein BR_{C} represents the concentration of base resin in the composition in parts per hundred, wherein S_{C} represents the concentration of solvent in the composition in parts per hundred, wherein C_{PS} represents a percent of particles in plurality of particles having an average particle size of 1 μm to 200 μm, wherein C_{ST} represents the surface tension of the composition, wherein BR_{ST} represents the surface tension of the base resin, and wherein the composition has a storage modulus of about 9×10⁻⁴ MPa to about 1×10⁻⁵ MPa. In some embodiments, the pre-assembled colorant includes colorant-coated microspheres, colorant-infused microspheres, colorant-plated pigment flakes, or combinations thereof. In other embodiments, the base resin comprises poly(styrene-butadiene), carboxylate-terminated poly(styrene-butadiene), or mixtures thereof. In still other embodiments, C_{ST} ranges from 20 mN/m to about 40 mN/m. In yet other embodiments, C_{ST} ranges from 25 mN/m to about 35 mN/m. The base resin may have a storage modulus of about 1×10⁻⁷ MPa to about 1×10⁻⁵ MPa. In one embodiment, the base resin has a storage modulus of about 1×10⁻⁵ MPa to about 1×10⁻³ MPa.

### BRIEF DESCRIPTION OF THE DRAWINGS

Further features and advantages of the invention can be ascertained from the following detailed description that is provided in connection with the drawings described below:

FIG. 1 is a writing instrument in accordance with an embodiment of the present disclosure.

### DETAILED DESCRIPTION OF THE INVENTION

The present disclosure relates to compositions that may be used to produce inks that may be removed after application. More specifically, the present disclosure relates to compositions that include a resin, a colorant, and a solvent mixture. The compositions may be used to fill a writing instrument, and the applied marking may be removed if desirable with a suitable erasing instrument such as an elastomer eraser.

### Composition

The compositions of the present disclosure include a base resin, a colorant, and a solvent or solvent system. Details regarding each component and the resulting composition are provided below.

### Base Resin

The composition includes a base resin in an amount of about 1 percent to 100 percent by weight based on the total weight of the composition. In one embodiment, the base resin is included in the composition in an amount within a range having a lower limit of about 5 percent or 10 percent or 20 percent or 30 percent or 40 percent or 50 percent and an upper limit of about 60 percent or 70 percent or 80 percent or 90 percent or 95 percent or 100 percent. For example, the base resin may be present in the composition in an amount of about 40 percent to about 90 percent by weight based on the total weight of the composition. In another example, the composition includes about 50 percent to about 95 percent base resin based on the total weight of the composition.

Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The base resin may any resin that maintains a high hold out, i.e., does not penetrate into the substrate, and has sufficient rollability. Hold out may be indicated by the surface energy/tension of the base resin. In some embodiments, the base resin has a surface tension of at least about 20 mN/m. In other embodiments, the surface tension of the base resin is about 20 mN/m to about 50 mN/m. In still other embodiments, the base resin has a surface tension of about 25 mN/m to about 45 mN/m.

Rollability can be evaluated in the context of storage modulus of the resin. As understood by those of ordinary skill in the art, storage modulus, which is essentially elasticity on the x-y plane, indicates how an ink will be able to resist sedimentation. In this regard, the base resin may have a storage modulus of about 1×10⁻⁷ MPa to about 1×10⁻³ MPa. In some embodiments, the base resin has a storage modulus of about 1×10⁻⁷ MPa to about 1×10⁻⁵ MPa. In other embodiments, the base resin has a storage modulus of about 1×10⁻⁵ MPa to about 1×10⁻³ MPa.

The molecular weight of resins suitable for use in compositions formed in accordance with the present disclosure may have a molecular weight greater than about 1000 amu. In some embodiments, the resin(s) used in a composition of the invention have a molecular weight of about 2500 amu or greater. For example, suitable resins for use in compositions formed according to the present disclosure may have a molecular weight of about 3000 amu or more. In one embodiment, the molecular weight of resins suitable for use in compositions formed according to the present disclosure is about 5000 amu or greater. In another embodiment, the molecular weight of a resin suitable for use in accordance with the present disclosure is about 10,000 amu or greater. For example, a resin suitable for use in compositions formed in accordance with the present disclosure has a molecular weight of about 20,000 amu or more. In other embodiments, the molecular weight of the resin may be about 1,000 amu to about 2,000,000 amu.

Suitable resins include, but are not limited to, poly(styrene-butadiene), carboxylate-terminated poly(styrene-butadiene), polyvinyl pyridine (PVC), and mixtures thereof. Commercially available carboxylated styrene-butadienes for use in accordance with the present disclosure include, but are not limited to, carboxylated styrene-butadiene emulsion polymers sold under the brand name of Rovene® from MC Polymers. In some embodiments, the Rovene® 4100 series may be used as the base resin. For example, Rovene® 4125 and Rovene® 4135 may be used as the base resin in compositions of the present disclosure. Commercially available examples of non-carboxylated styrene-butadiene include, but are not limited to, non-carboxylated fatty acid stabilized styrene-butadiene copolymers sold by BASF under the brand name of Butonal®. For example, Butonal® NS125 may be suitable as a base resin in compositions formed in accordance with the present disclosure. As would be understood by one of ordinary skill in the art, the carboxylated styrene-butadienes will have more cross-linking capability than their non-carboxylated counterparts and, as such, may be particularly useful when a higher molecular weight resin is desired. Without being bound any particular theory, the carboxylation also provides good adhesion to a substrate (that increases over time), high elasticity, and enhanced pigment binding capacity. The non-carboxylated styrene-butadienes may provide a composition with stable adhesion that does not increase over time and, thus, may be useful with certain substrates from a removability perspective.

In some embodiments, the base resin includes a blend of different base resins. In this embodiment, the composition of the present disclosure may include a blend of a first base resin and a second base resin in a ratio of about 5:95 to about 95:5. For example, the composition may include a first base resin and a second base resin in a ratio of about 10:90 to about 90:10 or about 15:85 to about 85:15 or about 20:80 to about 80:20 or about 30:70 to about 70:30 or about 40:60 to about 60:40. For example, the base resin may include two different carboxylated styrene-butadienes, two different non-carboxylated styrene-butadienes, or a carboxylated styrene-butadiene and a non-carboxylated styrene-butadiene.

### Colorant

The compositions of the present disclosure include at least one colorant. The composition includes a colorant in an amount of about 0.5 percent to about 20 percent by weight based on the total weight of the composition. In one embodiment, the colorant is included in the composition in an amount within a range having a lower limit of about 1 percent or 2 percent or 3 percent or 4 percent or 5 percent or 6 percent and an upper limit of about 10 percent or 12 percent or 14 percent or 16 percent or 18 percent or 20 percent. For example, the colorant may be present in the composition in an amount of about 1 percent to about 5 percent by weight based on the total weight of the composition. In another example, the composition includes about 4 percent to about 10 percent colorant based on the total weight of the composition. In still another example, the colorant is present in the composition in an amount of about 0.05 percent to about 2 percent by weight based on the total weight of the composition.

The colorant may be a pigment, a dye, or a combination thereof. As would be understood by those of ordinary skill in the art, while both pigments and dyes may be used to add color to a variety of materials, they are not the same. In particular, pigments are colored, usually inorganic compounds that are completely or nearly insoluble in water whereas dyes are usually organic, soluble compounds. In other words, pigments are finely ground particles of color that get suspended in a dispersing agent or vehicle. Dyes are chemicals that are dissolved in water or other liquid medium to create a colorant. In addition, while dyes chemically bind with the substrate to become part of the substrate, pigments are applied to the surface of the substrate, so they physically bind with the substrate.

In some embodiments, the colorant is pre-assembled. As used herein, “pre-assembled” refers to color-giving species that are pre-arranged in special three-dimensional matrices. Without being bound by any particular theory, pre-assembled colorants contribute to the high erasability of the compositions of the present disclosure. In particular, holding all other components and amounts constant, the use of commercially available organic pigment dispersions with un-assembled colorants provide partial erasability (at best). Indeed, in most cases, compositions with resins and pigment dispersions with un-assembled colorants dissolved in a solvent are not erasable.

In one embodiment, the colorant is a pure pigment. In some aspects, the pure pigment is a copper pigment, a chromium pigment, an aluminum pigment, a manganese pigment, a gold pigment, an arsenic pigment, a bismuth pigment, a cerium pigment, an iron pigment, a titanium pigment, a tin pigment, a zinc pigment, or a combination thereof. For example, the pure pigment may be an aluminum pigment, optionally containing urea-aldehyde-resin binders. A non-limiting example of such a pigment is commercially available under the brand name Grandal® offered for sale by Schlenk (Germany). More specifically, Grandal® W 6340 (Schlenk, Germany) may be used as the colorant in compositions of the present disclosure. The pigment may also be a fluorescent pigment, a pearlescent pigment, an iridescent pigment, or a combination thereof.

In some embodiments, pre-assembled colorants suitable for use in compositions of the present disclosure include colorant-coated microspheres. One example of a colorant-coated microsphere is Evoque™ 1180 from Dow (Midland, MI). In other embodiments, pre-assembled colorants suitable for use in compositions of the present disclosure include colorant-infused microspheres. An example of colorant-infused microspheres is Microsphere 230 MD offered by Dainichiseika Color & Chemicals Mfg. Co. (Japan) and urethane and methacrylate ester type spherical cross-linked pigments offered under the brand name Art Pearl by Negami (Japan). In still other embodiments, pre-assembled colorants suitable for use in compositions of the present disclosure include colorant-plated pigment flakes. An example of commercially available colorant-plated flake is Mearlin® Micro Brass 2302 offered by BASF. In yet other embodiments, pre-assembled colorants include a combination of two or more colorant-coated microspheres, colorant-infused microspheres, and colorant-plated pigment flakes.

In some embodiments, the shape of the colorant is spherical. In other embodiments, the shape of the colorant is not spherical. In still other embodiments, the colorant has a plate-like shape. In yet other embodiments, the composite colorant has an irregular shape.

The average particle size of the colorant is about 1 micron or greater. In some embodiments, the particle size is about 2 microns or more. In other embodiments, the average particle size is about 4 microns or more. Without being bound by any particular theory, this range of particle sizes prevent the colorant from a) being muted in color as a result of being absorbed in the pores of the substrate, b) being unavailable for erasure or removal as a result of getting trapped in the pores of the substrate, or c) both. In some aspects, the average particle size of the colorant is about 1 micron to about 200 microns. In other aspects, the average particle size of the colorant is about 5 microns to about 200 microns. For example, the average particle size of the colorant may range from about 5 microns to about 50 microns. By way of further example, the average particle size of the colorant may be about 25 microns to about 150 microns. In other aspects, the average particle size of the colorant is about 50 microns to about 1000 microns. For example, the average particle size of the colorant may be about 250 microns to about 750 microns.

In some embodiments, the colorant has between about 50 and 100 percent of particles with an average particle size of about 1 micron to about 200 microns. For example, about 75 and 99 percent of particles in the colorant may have an average particle size of about 1 micron to about 200 microns.

Inorganic pigments that agglomerate also suitable for use as a colorant in the composition of the present disclosure. Non-limiting examples of such pigments include crystals of metal compounds such as metal oxides. In this aspect, metal oxides such as titanium dioxide, zinc oxide, copper oxide, tin oxide, iron oxide, zirconium oxide, and the like are suitable for use as a colorant in accordance with the present disclosure. Mineral-based pigments such as talc may also be used as the colorant.

In addition, external stimuli-responsive pigment may be used. In one embodiment, the external stimuli may be temperature. A non-limiting example of such a temperature responsive pigment includes a blue thermochromic pigment from Art-n-Glow (Plano, TX).

### Solvent

The compositions may include a single solvent or a mixture of solvents. While surface tension ranges are discussed in greater detail below, in some embodiments, the solvent is selected such that the composition has a surface tension of about 20 mN/m or more. In one embodiment, the solvent is selected such that the composition has a surface tension of about 25 mN/m or more.

In some embodiments, the solvent has a surface tension of about 40 mN/m or more at room temperature. In other embodiments, the surface tension of the solvent is about 40 mN/m to about 75 mN/m. For example, the surface tension of the solvent may be about 45 mN/m to about 75 mN/m.

Non-limiting examples of suitable solvents for use in the compositions of the present disclosure include water, glycols (such as glycerol, propylene glycol, polyalkylene glycols, and diols), glycol ethers, poly(glycol) ethers, caprolactams, formamides, acetamides, and long chain alcohols. In some embodiments, the solvent may include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-alcohols of 30 carbons or less, 1,3-alcohols of 30 carbons or less, omega.-alcohols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, N-alkyl caprolactams, unsubstituted caprolactams, substituted formamides, unsubstituted formamides, substituted acetamides, unsubstituted acetamides, and combinations thereof.

When the composition includes a solvent system with more than one solvent, the first solvent may be any of the solvents listed above and the second solvent (or co-solvent) may include, but is not limited to, N-methyl pyrrolidone, 1,5-pentanediol, 2-pyrrolidone, diethylene glycol, triethylene glycol, tetraethylene glycol, 1,3-(2-methyl)-propanediol, 1,3,5-(2-methyl)-pentanetriol, tetramethylene sulfone, 3-methoxy-3-methylbutanol, glycerol, 1,2-alkyldiols, and combinations thereof. When included, the co-solvent concentration may range from about 10 to about 25 weight percent based on the total weight of the solvent system. In one embodiment, the solvent system includes about 10 to about 15 weight percent of the co-solvent based on the total weight of the solvent system. In this aspect, the total amount of solvent (with or without co-solvent) may be about 20 percent to about 50 percent by weight of the composition. For example, the total amount of solvent (with or without co-solvent) may range from about 25 percent to about 45 percent by weight of the composition.

### Additives and Fillers

Other additives may be added to the composition to further enhance the physical properties. In some embodiments, the compositions of the present invention include about 0.1 percent to about 5 percent by weight additive(s). In other embodiments, the compositions include about 0.5 percent to about 3 percent by weight additives. In this aspect, suitable additives include, but are not limited to, humectants, surfactants, biocides, antimicrobials, fungicides, rheological modifiers and processing aids, dispersants, defoamers, co-solvents, additional colorants, thermal stabilizers, scents, glitter, lubricants, plasticizers, preservatives, optical brighteners, antioxidants and combinations thereof.

For example, one or more preservatives, such as antimicrobial agents and fungicides, may be added to increase the shelf life of the compositions according to the present invention. Nonlimiting examples of suitable preservatives include Fungitrol@940, Kathon@ LX, Nuosept@95, Acticide@ LA, and Polyphase@ P100. Nonlimiting examples of suitable processing aids include Hydropalat@ 44. Lubricants or plasticizers, such as oleic acid, isobutyl stearate, polyoxyethylene alkali metal salt, dicarboxylic acid amide, phosphoric acid ester, and like, may be added to soften the compositions to improve the transfer of the colorant to the substrate. As the surfactant, for example, an anionic surfactant, a nonionic surfactant, or the like can be used.

Rheology modifiers may also be added to the compositions of the present disclosure to adjust the pseudoplastic flow state such that the compositions are suitable for use in writing instruments. Nonlimiting examples include alkali metal salts, amine salts, alkanolamine salts of cross-linked acrylic acid polymers, associative urethane resin viscosity modifiers, and combinations thereof. If used, the rheology modifier may be used in an amount of about 0.01 percent to about 5 percent by weight based on the total weight of the composition. In one embodiment, the composition includes about 0.1 percent to about 5 percent by weight based on the total weight of composition

In some embodiments, an additional colorant may be used that introduces a non-erasable colorant into the composition. For example, it may be desirable to formulate a composition that, once applied, can change color upon rubbing and erasing the rubberized portion. When included, the amount of additional colorant is generally based on the desired color intensity and stability of the composition. However, in one embodiment, the composition includes at least about 0.1 percent additional colorant by weight of the composition. In another embodiment, the composition includes about 15 percent or less additional colorant by weight of the composition. In yet another embodiment, the composition includes about 30 percent or less additional colorant by weight of the total composition. For example, the additional colorant may be present in the composition in an amount of about 10 percent to about 30 percent by weight of the composition.

Suitable additional colorants include, but are not limited to, water-soluble dyes. In this regard, the water-soluble dyes may be anionic or cationic. Non-limiting examples of dyes for use as the additional colorant include basic, acid, direct, and reactive dyes such as Food Black No. 1, Food Black No. 2, Food Red No. 40, Food Blue No. 1, Food Yellow No. 7, and the like; FD & C dyes; Acid Black dyes (No. 1, 7, 9, 24, 26, 48, 52, 58, 60, 61, 63, 92, 107, 109, 118, 119, 131, 140, 155, 156, 172, 194, and the like); Acid Red dyes (No. 1, 8, 32, 35, 37, 52, 57, 92, 115, 119, 154, 249, 254, 256, and the like), Acid Blue dyes (No. 1, 7, 9, 25, 40, 45, 62, 78, 80, 92, 102, 104, 113, 117, 127, 158, 175, 183, 193, 209, and the like); Acid Yellow dyes (No. 3, 7, 17, 19, 23, 25, 29, 38, 42, 49, 59, 61, 72, 73, 114, 128, 151, and the like); Direct Black dyes (No. 4, 14, 17, 22, 27, 38, 51, 112, 117, 154, 168, and the like); Direct Blue dyes (No. 1, 6, 8, 14, 15, 25, 71, 76, 78, 80, 86, 90, 106, 108, 123, 163, 165, 199, 226, and the like); Direct Red dyes (No. 1, 2, 16, 23, 24, 28, 39, 62, 72, 227, 236, and the like); Direct Yellow dyes (No. 4, 11, 12, 27, 28, 33, 34, 39, 50, 58, 86, 100, 106, 107, 118, 127, 132, 142, 157, and the like); anthraquinone dyes, monoazo dyes, disazo dyes, phthalocyanine derivatives, including various phthalocyanine sulfonate salts, aza annulenes, formazan copper complexes, triphenodioxazines, Bernacid Red 2BMN; Pontamine Brilliant Bond Blue A; Pontamine; Cibracron Brilliant Red 38-A (Reactive Red 4), available from Aldrich Chemical; Drimarene Brilliant Red X-2B (Reactive Red 56), available from Pylam, Inc.; Levafix Brilliant Red E-4B, available from Mobay Chemical; Levafix Brilliant Red E-6BA, available from Mobay Chemical; Procion Red H8B (Reactive Red 31), available from ICI America; Direct Brilliant Pink B Ground Crude, available from Crompton & Knowles; Cartasol Yellow GTF Presscake, available from Sandoz, Inc.; Cartasol Yellow GTF Liquid Special 110, available from Sandoz, Inc.; Yellow Shade 16948, available from Tricon, Basacid Black X34 (BASF X-34), available from BASF, Carta Black 2GT, available from Sandoz, Inc.; Neozapon Red 492 (BASF); Orasol Red G (Ciba-Geigy); Direct Brilliant Pink B (Crompton-Knolls); Aizen Spilon Red C-BH (Hodogaya Chemical Company); Kayanol Red 3BL (Nippon Kayaku Company); Levanol Brilliant Red 3BW (Mobay Chemical Company); Levaderm Lemon Yellow (Mobay Chemical Company); Spirit Fast Yellow 3G; Aizen Spilon Yellow C-GNH (Hodogaya Chemical Company); Sirius Supra Yellow GD 167; Cartasol Brilliant Yellow 4GF (Sandoz); Pergasol Yellow CGP (Ciba-Geigy); Orasol Black RL (Ciba-Geigy); Orasol Black RLP (Ciba-Geigy); Savinyl Black RLS (Sandoz); Dermacarbon 2GT (Sandoz); Pyrazol Black BG (ICI); Morfast Black Concentrate A (Morton-Thiokol); Diazol Black RN Quad (ICI); Orasol Blue GN (Ciba-Geigy); Savinyl Blue GLS (Sandoz); Luxol Blue MBSN (Morton-Thiokol); Sevron Blue 5GMF (ICI); Basacid Blue 750 (BASF); Bernacid Red, available from Berncolors, Poughkeepsie, N.Y.; Pontamine Brilliant Bond Blue; Berncolor A.Y. 34; Telon Fast Yellow 4GL-175; BASF Basacid Black SE 0228; various Reactive dyes, including Reactive Black dyes, Reactive Blue dyes, Reactive Red dyes including Reactive red 180, and the like, Reactive Yellow dyes including Reactive yellow 37, as well as mixtures thereof. When such dyes are employed as the additional colorant, the composition may include about 0.1 percent to about 15 percent dye by weight of the composition. In one embodiment, the composition includes a dye as the additional colorant in an amount of about 1 percent to about 6 percent by weight of the composition. In another embodiment, the additional colorant is a dye and is included in an amount of about 1.5 percent to about 4 percent by weight of the composition.

Suitable additional colorants also include, but are not limited to, pigments. When pigments are employed as the additional colorant, the composition may include about 2 percent to about 20 percent pigment by weight of the composition. In one embodiment, the composition includes a pigment as the additional colorant in an amount of about 5 percent to about 10 percent by weight of the composition. In another embodiment, the additional colorant is a dye and is included in an amount of about 1.5 percent to about 4 percent by weight of the composition.

The composition may also include filler(s). Suitable non-limiting examples of fillers include glass (e.g., glass flake, milled glass, and microglass), mica, and combinations thereof. Metal oxide and metal sulfate fillers are also contemplated for inclusion in the composition. Suitable metal fillers include, for example, particulate, powders, flakes, and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof. Suitable metal oxide fillers include, for example, zinc oxide, iron oxide, aluminum oxide, titanium oxide, magnesium oxide, and zirconium oxide. Suitable metal sulfate fillers include, for example, barium sulfate and strontium sulfate.

In some embodiments, the composition of the present disclosure includes colored fillers having a particle size of about 1 micron or more. For example, a suitable colored filler may have a particle size of about 2 microns to about 20 microns. In one embodiment, a suitable colored filler has a particle size of about 2 microns to about 10 microns. In another embodiment, a suitable colored filler has a particle size of about 2 microns to about 8 microns.

When included, the fillers may be in an amount of about 1 to about 25 parts by weight per 100 parts of the total composition. In one embodiment, the composition includes at least one filler in an amount of about 5 to about 20 or about 8 to about 15 parts by weight per 100 parts of the total composition. In another embodiment, the composition includes at least one filler in an amount of about 8 to about 14 or about 10 to about 12 parts by weight per 100 parts of the total composition. In yet another embodiment, the composition includes at least one filler in an amount of about 10 to about 17 or about 12 to about 15 parts by weight per 100 parts of the total composition. In yet another embodiment, the composition includes at least one filler in an amount of about 10 to about 16 or about 12 to about 15 parts by weight per 100 parts of the total composition. In a further embodiment, the composition includes at least one filler in an amount of about 12 to about 18 or about 14 to about 16 parts by weight per 100 parts of the total composition.

In some embodiments, more than one type of additive and/or filler may be included in the composition. For example, the composition may include a first filler in an amount from about 5 to about 20 or about 8 to about 17 parts by weight per 100 parts total rubber and a second filler in an amount from about 1 to about 10 or about 3 to about 7 parts by weight per 100 parts total composition. In another example, the composition may include a first filler in an amount from about 7 to about 13 or about 9 to about 12 parts by weight per 100 parts total composition and a second filler in an amount from about 2 to about 8 or about 4 to about 6 parts by weight per 100 parts total composition. In yet another example, the composition may include a first filler in an amount from about 10 to about 15 or about 13 to about 14 parts by weight per 100 parts total composition and a second filler in an amount from about 2 to about 9 or about 3 to about 7 parts by weight per 100 parts total composition. In a further example, the composition may include a first filler in an amount from about 10 to about 15 or about 13 to about 14 parts by weight per 100 parts total composition and a second filler in an amount from about 13 to about 18 or about 14 to about 16 parts by weight per 100 parts total composition.

### Properties

The compositions of the present disclosure provide many advantages over conventional ink compositions and thermochromic ink compositions. In this regard, a composition of the present disclosure may be removable over a range of substrates including semi-porous and porous substrates. In addition, the removability of the composition may be accomplished using a large range of eraser materials. Moreover, the compositions of the present disclosure provide more vivid markings as compared to thermochromic ink compositions. Furthermore, the compositions of the present disclosure are temperature stable, which allow for longer shelf-life and usability. Finally, the removability of the composition once applied is not reversible. Indeed, unlike other ink compositions that purport to be erasable, once the composition of the present disclosure is erased, the marking/color will not reappear even with an extreme drop in temperature.

### Surface Tension

The compositions of the invention preferably have a surface tension sufficient to avoid penetration into the substrate. In this aspect, the surface tension of the composition may be about 25 mN/m or more. In some embodiments, the surface tension of the composition is about 65 mN/m or less. In other embodiments, the composition has a surface tension of about 25 mN/m to about 60 mN/m. In still other embodiments, the composition has a surface tension of about 28 mN/m to about 50 mN/m.

### Storage Modulus

The compositions of the invention preferably have storage modulus sufficient to allow the applied ink to be removed as a single film. In some embodiments, the compositions of the present disclosure have an storage modulus of about 9×10−4 MPa to about 1×10−5 MPa.

### Removability

When applied to a substrate, the composition of the present disclosure may be removed from the substrate. In other words, marks made by the compositions of the present disclosure are at least partially removable with elastomeric erasers. In some embodiments, marks made by the compositions of the present disclosure are substantially removable with elastomeric erasers. In this regard, the compositions may be substantially or mostly removed from an intended substrate with minimal smearing using an elastomeric eraser.

After applying the composition with a writing instrument, such as a ballpoint pen or a marker, once dried, the applied composition forms a film on the substrate that may be removed with an erasing material. Since the film is peeled or rolled off, the compositions of the present disclosure may be more easily removable than prior art ink compositions.

### Relationships

The compositions of the present disclosure may be described with certain relationships between the components, the composition, and the properties thereof. For example, in one embodiment, the composition may be defined by the relationship shown in Equation I below:

$$\frac{B {R}_{C} * {S}_{C}}{{C}_{P S} - \frac{{C}_{ST}}{B {R}_{ST}}} \leq 2 \qquad ( I )$$

where BR_{C} and S_{C} represent the concentration of base resin and solvent in the composition (expressed as weight fraction), respectively; C_{PS} represents the percent of particles in the colorant with an average particle size of 1 μm to 200 μm; and C_{ST} and BR_{ST} represent the surface tension of the composition and base resin, respectively. In another embodiment,

$$0.5 < \frac{B {R}_{C} * {S}_{C}}{{C}_{P S} - \frac{{C}_{ST}}{B {R}_{ST}}} < 2$$

In still another embodiment,

$$0.8 < \frac{B {R}_{C} * {S}_{C}}{{C}_{P S} - \frac{{C}_{S T}}{B {R}_{S T}}} < 1.4$$

In some aspects,

$$1 < \frac{B {R}_{C} * {S}_{C}}{{C}_{P S} - \frac{{C}_{ST}}{B {R}_{ST}}} < 2$$

### Writing Instrument

Writing instruments of varying types may be filled with the compositions of the present disclosure. In some embodiments, the compositions of the present disclosure may be used in a writing instrument that includes an ink storage compartment, and a tip attached to one end of the ink storage compartment. The ink storage compartment and the tip may be directly connected together, or may be connected together through a connection member. The tip may be a felt tip or a ball point tip. If the writing instrument is a ballpoint pen, the ball diameter used is not particularly limited and can range from about 0.2 mm to about 1.6 mm.

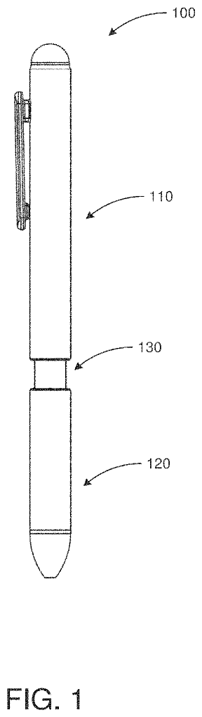

In one embodiment, a writing instrument as shown in FIG. 1 may be filled with compositions of the present disclosure. For example, a writing instrument 100 may include body 110, a tip 120, and a connection member 130.

In some embodiments, the writing instrument may include an eraser removably or fixedly attached to the writing instrument. The eraser is discussed in further detail below.

### Eraser

Erasers of varying types may be used to remove the compositions of the invention once applied to a substrate. In some embodiments, the eraser is formed from an elastomeric material. For example, the eraser may be formed of a thermoplastic elastomer. In other embodiments, the eraser is formed from natural rubber, synthetic rubbers such as neoprene, siloxane-containing materials, or combinations thereof.

### EXAMPLES

The invention is further illustrated by the following examples. It should be understood that the examples below are for illustrative purposes only. These examples should not be construed as limiting the scope of the invention.

Compositions formed in accordance with the present disclosure are provided in the examples below. These examples provide the components included in each rubber formulation. Concentrations of each component are provided in parts by weight per 100 parts of the total composition unless stated otherwise.

### Example 1

Components were mixed according to the stated ratios in Table 1 below. After a homogeneous mixture was achieved, the resultant compositions were inserted into marker writing systems using injection syringes. The marker writing systems were left to prime and marks were then made on white copy paper. The marks were then erased (within about 2 to about 10 seconds of application) using an elastomer eraser. The erasability of each composition was assessed visually using a Likert Scale. Compositions made in accordance with the present disclosure included Butonal® NS175 (available from BASF) as the base resin, pre-assembled colorants (Microsphere 230MD (Dainichiseikai, Japan) in Example 1 and C-800 BKG (King industries, Norwalk, CT) in Example 2), and a solvent system that includes a solvent (water) and a co-solvent (propylene glycol). The comparative examples included either a base resin of the present disclosure and a conventional colorant (a colorant with an average particle size of 1 μm such as WR170 commercially available from Arbor Colorant Corporation, Howell, MI) (Comp. Ex. A) or a conventional acrylic resin (Joncryl® 562 from BASF) and the pre-assembled colorant used in Example 1 (Comp. Ex. B), along with the same solvent system used in Example 1.

TABLE 1
Compositions

| | | | | |
|---|---|---|---|---|
| | | | Comp. | Comp. |
| Component | Ex. 1 | Ex. 2 | Ex. A | Ex. B |

Resin

| | | | | |
|---|---|---|---|---|
| Base | 40 | 40 | 40 | |
| Conventional | | | | 40 |

Colorant

| | | | | |
|---|---|---|---|---|
| Pre-assembled | 10 | 15 | | 10 |
| Conventional | | | 10 | |

Solvent System

| | | | | |
|---|---|---|---|---|
| Solvent | 40 | 35 | 40 | 40 |
| Co-solvent | 10 | 10 | 10 | 10 |
| Total | 100 | 100 | 100 | 100 |

The compositions in Table 1 were tested for erasability on copy paper on a scale of 1 to 5 where 1 is the worst and 5 is the best. As evidenced by Table 2, the compositions of the present disclosure had a high erasability as compared to the control compositions.

TABLE 2
Erasability

| | Ex. 1 | Ex. 2 | Comp. Ex. A | Comp. Ex. B |
|---|---|---|---|---|
| Erasability | 5 | 5 | 1 | 2 |

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The compositions described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A composition, comprising:
a base resin;
a pre-assembled colorant having a plurality of particles therein; and
a solvent system, wherein the composition satisfies the following relationship:
$$\frac{B {R}_{C} * {S}_{C}}{{C}_{P S} - \frac{{C}_{ST}}{B {R}_{ST}}} \leq 2$$
wherein BR_{C} represents the weigh fraction of base resin in the composition, wherein S_{C} represents the weight fraction of solvent in the composition, wherein C_{PS} represents a percent of particles in plurality of particles having an average particle size of 1 μm to 200 μm, wherein C_{ST} represents the surface tension of the composition, and wherein BR_{ST} represents the surface tension of the base resin.

2. The composition of claim 1, wherein the pre-assembled colorant comprises colorant-coated microspheres, colorant-infused microspheres, colorant-plated pigment flakes, or combinations thereof.

3. The composition of claim 1, wherein the base resin comprises poly(styrene-butadiene), carboxylate-terminated poly(styrene-butadiene), or mixtures thereof.

4. The composition of claim 1, wherein C_{ST} ranges from 20 mN/m to about 40 mN/m.

5. The composition of claim 4, wherein C_{ST} ranges from 25 mN/m to about 35 mN/m.

6. The composition of claim 1, wherein the composition has a storage modulus of about 9×10⁻⁴ MPa to about 1×10⁻⁵ MPa.

7. The composition of claim 1, wherein the base resin has a storage modulus of about 1×10⁻⁷ MPa to about 1×10⁻³ MPa.

8. A composition, comprising:
a base resin having a storage modulus of about 1×10⁻⁷ MPa to about 1×10⁻³ MPa;
a pre-assembled colorant having a plurality of particles therein; and
a solvent system, wherein the composition satisfies the following relationship:
$$\frac{B {R}_{C} * {S}_{C}}{{C}_{P S} - \frac{{C}_{ST}}{B {R}_{ST}}} \leq 2$$
wherein BR_{C} represents the weigh fraction of base resin in the composition, wherein S_{C} represents the weight fraction of solvent in the composition, wherein C_{PS} represents a percent of particles in plurality of particles having an average particle size of 1 μm to 200 μm, wherein C_{ST} represents the surface tension of the composition, wherein BR_{ST} represents the surface tension of the base resin, and wherein the composition has a storage modulus of about 9×10⁻⁴ MPa to about 1×10⁻⁵ MPa.

9. The composition of claim 8, wherein the pre-assembled colorant comprises colorant-coated microspheres, colorant-infused microspheres, colorant-plated pigment flakes, or combinations thereof.

10. The composition of claim 8, wherein the base resin comprises poly(styrene-butadiene), carboxylate-terminated poly(styrene-butadiene), or mixtures thereof.

11. The composition of claim 8, wherein C_{ST} ranges from 20 mN/m to about 40 mN/m.

12. The composition of claim 11, wherein C_{ST} ranges from 25 mN/m to about 35 mN/m.

13. The composition of claim 8, wherein the base resin has a storage modulus of about 1×10⁻⁷ MPa to about 1×10⁻⁵ MPa.

14. The composition of claim 8, wherein the base resin has a storage modulus of about 1×10⁻⁵ MPa to about 1×10⁻³ MPa.
